(19) United States
(12) Patent Application Publication
(10) Pub. No.: US 2005/0011992 A1
(43) Pub. Date: Jan. 20, 2005

(54) Reduction of aircraft fuel consumption

(76) Inventor: Ming-Shean Ueng, Hollywood, FL (US)

Correspondence Address: Ming-Shean UENG, 2615 N. 26th Terrace, Hollywood, FL, 33020, US

(21) Appl. No.: 10/621,729

(22) Filed: Jul. 17, 2003

(51) Int. Cl. B64D 11/00

(52) U.S. Cl. 244/118.5

(57) ABSTRACT

An extreme low drag aircraft is an aircraft having an extreme low height of cabin, that is, an extreme low height of fuselage to reduce a large percentage of cross sectional area so that the aircraft drag force can be reduced to a minimum, to reduce a certain portion of structural weight which affects the lift force required, to increase a certain percentage of flight speed and flight range, and to reduce a certain percentage of fuel consumption. This is accomplished by having the pilot seat, co-pilot seat and passenger seats designed and arranged with a minimum height in a lying or reclining position with transition when entering, leaving and remaining in the flight compartment and the cabin during flight.

### BACKGROUND OF THE INVENTION

In the aircraft manufacturing, a lot of factors have to be considered: total cost, fuel price, speed, economical, number of passengers each flight, luxury, comfort, and etc. With the retiring of Concord aircraft it is getting critical.

For most of the aircraft, passengers usually can stand to walk in the cabin. For some other aircraft passengers may half-standing, that is, bend head, waist and knees, to walk to seat to sit, in order to reduce the height of the cabin. Since the cross sectional area is directly in proportion to the drag force, so far, half-standing to walk to sit is the extreme end.

This invention breaks the limitation by introducing a lying position or reclining position with transition for pilot, co-pilot and passengers when entering, leaving and remaining in the pilot compartment and the cabin during the flight, especially for the business jet, light business jet and supersonic business jet. For large business jet, long-range business jet, regional jet, and all heavy wide-body jet, passengers in lying or reclining position is feasible, comfortable and acceptable.

For the business jet and the light business jet, a lying or reclining position seems not “acceptable”. But with additional concerns to introduce more features it could become “acceptable”. As the aircraft is not of the wide-body space of comfortable with feeling of royal luxury and dignity is not available. To confine VIPs, “Very Important Persons” in a very small space cabin looks like some kinds of “punishment” as compared with royal, luxury commercial flight with wide-body and wide space.

Therefore, in high speed flight as the time is close to the commercial flight or shorter, it is not necessary to “sit” in the confined seat. See how scared with crying, and refusing to re-enter the commercial aircraft cabin during a transit flight for a child when he experienced how not-fun to sit on the seat inside the aircraft as compared with the very first time his parents took him happily entering the aircraft cabin while he expected it would be fun - - - airplane! airplane!

For this invention, while lying down in the seat in the cabin, one can sleep, or watch movies, or watch TV, or listen to favorate music, or having health care with seat vibrating-like massage, or chating, or brain-storm meeting with more thinking than talking.

It is the idea to increase the flight speed so that a lavatory is not required for light business jet as the center of gravity is very sensitive for a passenger “walking” to and from the lavatory. For VIPs, they can claim the credits due to their giantic sacrifice of royal luxury in exchange of reduced cost of fuel and total cost of aircraft for the company and thus, for all employees and even stock holders in a world wide aspect with some disadvantages and some advantages.

### DESCRIPTION OF THE DRAWING

FIG. 1 is a top view of an aircraft, and

FIG. 2 is a front view on the left side of the aircraft cabin.

### DESCRIPTION OF THE INVENTION

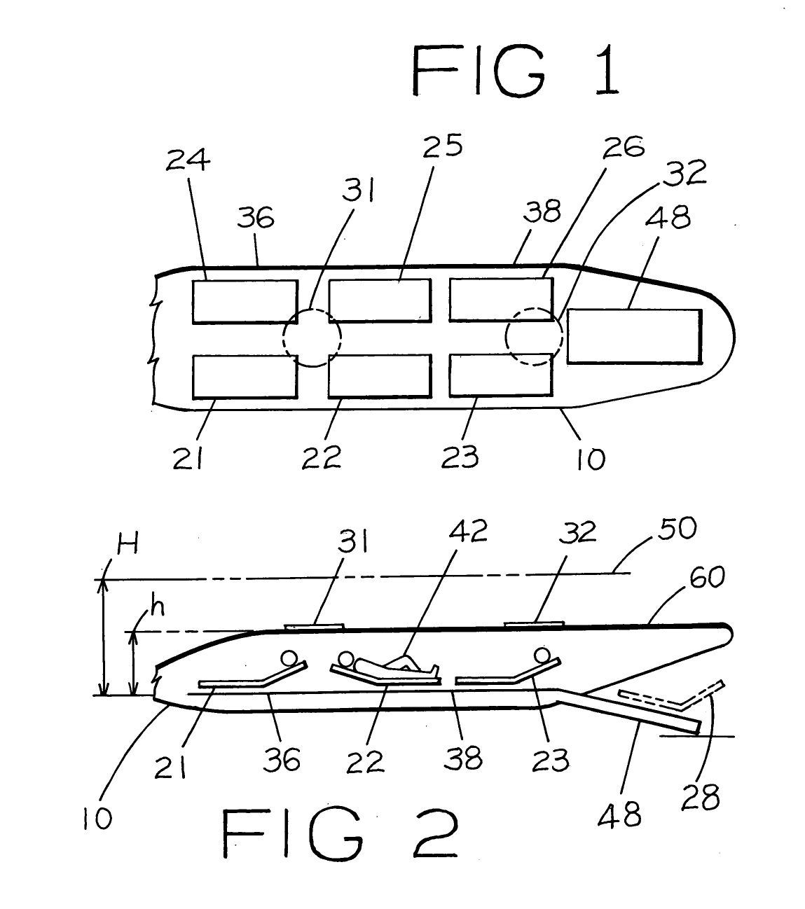

In FIG. 1, there shows a fuselage 10 layout of six seats 21, 22, 23, 24, 25 and 26 for a pilot 21 and a co-pilot or a passenger 24 at the pilot compartment 36; and for four passengers 22, 23, 25 and 26 at the cabin 38. The number of passengers and seating configurations may be changed as required.

To enter or to leave the aircraft, two doors 31 and 32 are provided at the top portion of the fuselage 10. In addition, a lower door 48 is located at the rear lower side of the fuselage 10. Each of the seats 21, 22, 23, 24, 25 and 26, can be sliding in or out with arrangement of rails, tracks, rollers, control cables, latches, locks, stops, and etc. All seats may be detachable. Those are generally understood and not shown.

In FIG. 2, the front view on the aircraft left side of fuselage 10 is shown. The pilot seat 21 is “facing” forward as well as passenger seat 23. A passenger 42 in position of seat 22 is “facing” rearward in a typical recline position like sitting in a regular recliner. At the rear lower door 48, a seat 28 in phantom line is ready to receive a passenger to slide into the flight compartment 36 or the cabin 38. The entrance doors or emergency exits 31 and 32 are located at the top of the fuselage 10.

The horizontal line 50 is the usual, original height H of the cabin. And the horizontal line 60 is the new, reduced height h of the cabin of this invention.

The fuselage cross section can be of round in shape, or oval, or rectangular with corner radii, or rectangular with full radius on both sides, or of any required shape as a compromise of aeronautical theories and the real world considerations.

The descriptions and illustrations of this invention mentioned above are those of the most preferred embodiments and no unnecessary limitations should be understood therefrom as modification will be obvious to those skilled in the art.

1. An extreme low height aircraft is accomplished by introducing a lying position or reclining position with transition for pilot, co-pilot and passengers in entering, leaving and remaining on seats during flight in the pilot compartment and the cabin.

2. An extreme low height aircraft is accomplished by introducing a lying position or reclining position with transition for pilot, co-pilot and passengers in entering, leaving and remaining on seats during flight in the pilot compartment and the cabin; and by introducing means to enter and to leave the pilot compartment and the cabin.

3. In claim 2, wherein said means to enter and to leave the pilot compartment and the cabin is accomplished by providing a plural of entrance doors on the top portion of the fuselage.

4. In claim 2, wherein said means to enter and to leave the pilot compartment and the cabin is accomplished by providing an entrance door at the rear lower portion of the aircraft where each seat can be sliding in and out with a combination of tracks, rails, rollers, control cables, stops, latches, locks, and etc.

5. In claim 2, wherein said means to enter and to leave the pilot compartment and the cabin is accomplished by providing a plural of entrance doors on the top portion of the fuselage; and by providing an entrance door at the rear lower portion of the aircraft where each seat can be sliding in and out with a combination of tracks, rails, rollers, control cables, stops, latches, locks, and etc.
